(19) United States
(12) Patent Application Publication
(10) Pub. No.: US 2006/0158343 A1
(43) Pub. Date: Jul. 20, 2006

(54) Method for setting home code of home network system

(75) Inventors: Koon Seok Lee, GYEONGSANGNAM-DO (KR); Yong Tae Kim, Gyeongsangnam-do (KR); Seung Myun Baek, Gyeongsangnam-do (KR)

Correspondence Address: MCKENNA LONG & ALDRIDGE LLP, 1900 K STREET, NW, WASHINGTON, DC, 20006, US

(73) Assignee: LG ELECTRONICS INC.

(21) Appl. No.: 10/534,497

(22) PCT Filed: Dec. 5, 2003
(86) PCT No.: PCT/KR03/02669

§ 371 Date: Feb. 3, 2006

(30) Foreign Application Priority Data
Dec. 6, 2002 (KR) 10-2002-0077316

(51) Int. Cl. H04Q 1/00; H04L 12/28

(52) U.S. Cl. 340/825.52; 340/825.22; 340/825.69; 340/310.16

(57) ABSTRACT

Disclosed is method for setting a home code of a home network system, the method including the steps of: creating the home code of the first adaptor; determining whether or not the home code is duplicated; and if the home code is not duplicated, setting the home code of the first adaptor to the second adaptor.

### TECHNICAL FIELD

The present invention relates to a home network system, and more particularly, to a method for setting a home code of a home network system.

### BACKGROUND ART

In a home network system, various home appliances, that is, a plurality of electronic home appliances of a personal computer, a portable phone, a refrigerator, a washing machine, an electronic oven and the like are connected with one another and controlled through one network.

In the home network system, a main appliance connected with each of the appliances through the home network is required so as to connect and control various home appliances. In addition, home networking can be realized only under environment where a protocol to control various signals using one integrated signal is provided on a communication bus such that one main appliance controls all peripheral home appliances, and a user should be allowed to see each appliance motion and recognize its current operation state.

However, the above-described conventional home network system has a drawback in that since networks used in the respective homes is connected by the same communication line adjacent networks equipped with the same appliance may influence one another.

In other words, when two adjacent homes A and B are respectively networked with a refrigerator, a washing machine, an air conditioner, an electronic oven, a personal computer (PC) and the like, their networks are connected by a communication bus being one line.

Accordingly, if a user transmits an execution code value and a code value of the washing machine to the washing machine through the PC so as to allow the washing machine of the home A to be in operation, the washing machine of the home A is operated according to the execution code value. However, there may be caused a problem in that the execution code value is transmitted even to the home B via the communication bus to thereby permit the washing machine of the home B to be operated unnecessarily.

Further, even though the appliance of the home A is operated by wireless communication, the appliance of the adjacent home B located within an effective radius of a wireless signal is also operated together.

Accordingly, in order to solve the above drawbacks, it is essential that the home code be set in the home network system. Home code setting has been made in a manner where a master refers to home code management data for manual input at the time of setting-up of the home network.

However, in case the master refers to the data for manual input, the home code can be not only recognized to the master, but also it can be also exposed to a third party. For example, in case the third party recognizes the home code of a corresponding home, a crime prevention system can be released or an admission door can be opened.

### DISCLOSURE OF THE INVENTION

Accordingly, the present invention is directed to a method for setting a home code of a home network system that substantially obviate one or more of the problems due to limitations and disadvantages of the related art.

An object of the present invention is to provide a method for setting a home code of a home network system in which the home code can be set only with simple key input, and home code setting and managing can be perfectly secured.

Additional features and advantages of the invention will be set forth in the description which follows, and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, there is provided a method for setting a home code of a home network system, the method including the steps of: creating the home code of the first adaptor; determining whether or not the home code is duplicated; and if the home code is not duplicated, setting the home code of the first adaptor to the second adaptors.

Herein, the determining step includes the steps of: transmitting a request packet from the network managing unit to the first adaptor; adding the home code of the first adaptor to the request packet; transmitting the request packet having the home code to other networks by wireless or through the power line; and determining that the home code is not duplicated in case there is no response signal to the request packet, and determining that the home code is duplicated in case there is the response signal to the request packet.

To further achieve these and other advantages and in accordance with the purpose of the present invention, there is provided a method for setting a home code of a home network system, the method including the steps of: transmitting a home code create command to the first adaptor from the network managing unit according to a user's command; creating a home code according to the home code create command at the first adaptor; determining whether or not the home code is duplicated by the first adaptor; if the home code is not duplicated, transmitting a home code setting command from the network managing unit to the first adaptor; and setting the home code of the second adaptors according to the home code setting command at the first adaptor.

Herein, the home code setting step includes the steps of: annexing the home code of the first adaptor to a head of the home code setting command; transmitting the home code setting command having the home code to the second adaptors; and setting the home code annexed to the head of the home code setting command to the home code of the second adaptors.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a block diagram illustrating a construction of a home network system according to the present invention; and

FIG. 2 is a flow chart illustrating a method for setting a home code of a home network system according to the present invention.

### BEST MODE FOR CARRYING OUT THE INVENTION

Reference will now be made in detail to the preferred embodiments of the present invention, examples of which are illustrated in the accompanying drawings.

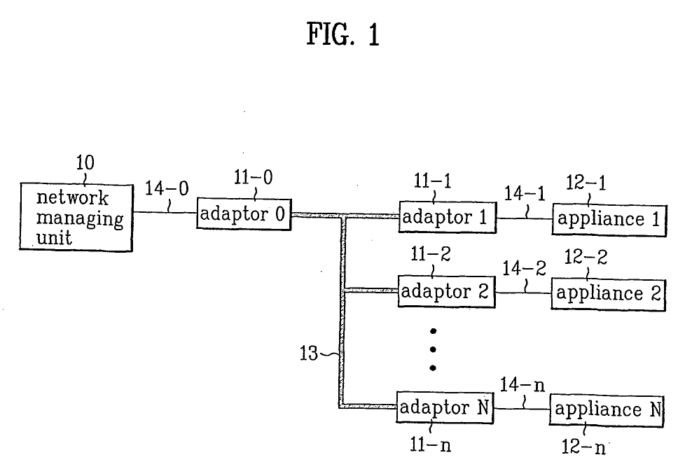

FIG. 1 is a block diagram illustrating a construction of a home network system according to the present invention.

As shown in FIG. 1, the home network system according to the present invention includes a plurality of appliances 12-1 to 12-n disposed at a home such as an electric home appliance and the like; and a network managing unit 10 having a program and a user interface for managing the plurality of appliances 12-1 to 12-n.

Herein, the appliances 12-1 to 12-n are respectively connected with adaptors 11-1 to 11-n through serial interfaces 14-1 to 14-n. The network managing unit 10 is also connected with the adaptors 11-1 to 11-n through a serial interface 14-0 and is connected with other home networks through a communication bus. The adaptors 11-1 to 11-n can be embedded into or externally installed at the appliances 12-1 to 12-n, and the adaptor 11-0 can be also embedded into or externally installed at the network managing unit 10. Additionally, the adaptors 11-1 to 11-n and the adaptor 11-0 are connected with one another through a power line 13.

The network managing unit 10 is a device only for a personal computer or a network. The adaptors 11-0 to 11-n are power line carrier (PLC) modems or wireless modems, and have a default value ‘0×00000000’ of the home code at the time of initial shipment.

The present invention is based on a principle as below so as to allow a simple and convenient setting and a perfect security of the home code. That is, the home code cannot be detected by a user or a master, the home code value cannot be detected through the power line, and the home code is just only created, set and managed only at the adaptor 11-0 connected with the network managing unit 10 and is not known to the network managing unit 10.

The adaptors 11-0 to 11-n receive data through the serial interfaces 14-0 to 14-n and process the received data in itself according to need, without transmitting to the power line 13. Further, data received through the power line 13 is not transmitted to the serial interfaces 14-0 to 14-n.

Further, since the home code can be expressed as many as four bytes (32 bits), that is, as many as 2³², a unique value can be provided for 4,294,967,295 homes.

However, since power line communication does not actually get out of a predetermined range, that is, from a range of one hundred meter radius due to a limited range of signal transmission, the home located within the range of one hundred meter radius actually has one of the numbers of four bytes that is set as the home code.

The method for setting the home code of the home network system according to the present invention is described as follows.

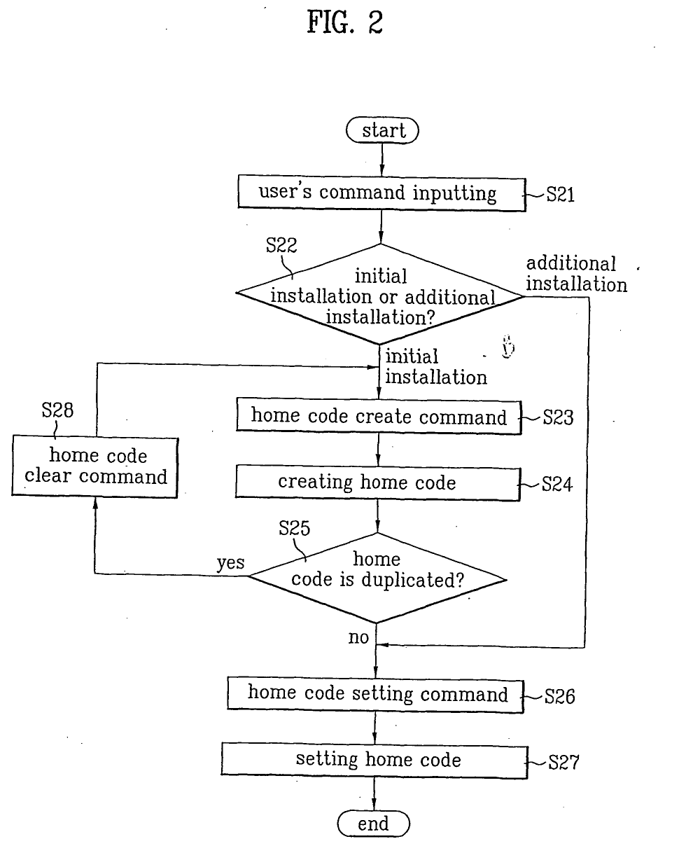

FIG. 2 is a flow chart illustrating the method for setting the home code of the home network system according to the present invention.

As shown in FIG. 2, firstly, if the home network system is powered-on, the user commands the network managing unit 10 to set the home code of the home network system through the user interface (S21).

After that, the network managing unit 10 recognizes a user's command to determine whether the appliances 12-1 to 12-n are initially installed or, the home code is already set to each of the appliances and then a new appliance is additionally installed (S22). For this, the network managing unit 10 confirms at initial booting whether or not the appliance is already connected to the network managing unit 10. If the appliance is already connected, it is determined to be an additional installation, and if the appliance is not connected, it is determined to be an initial installation.

In the step S22, if it is determined to be the initial installation, the network managing unit 10 commands the adaptor 11-0 connected to itself to create the home code (S23). At this time, the network managing unit 10 transmits a “home code create command” packet to the adaptor 11-0 through the serial interface 14-0 (S23).

Additionally, the adaptor 11-0 receiving the home code create command randomly creates the home code of itself (S24). Herein, the method for creating the home code can be proposed severally. Firstly, a method of combining a timing count value and an arbitrary value is proposed. The timing count value is timing information included in the home code create command packet or a count value of a timer included in the adaptor 11-0, and the arbitrary value is an initial code that is given to the adaptor 11-0 when the adaptor 11-0 is produced. In a second method for creating the home code, a random number generator can be used to create the home code. The home code created in the above methods has four bytes.

Next, the network managing unit 10 confirms whether or not the home code created at the adaptor 11-0 is already used in other home adaptors or appliances. That is, it is determined whether or not the home code of the adaptor 11-0 is duplicated (S25). For this, after the home code is created at the adaptor 11-0, the network managing unit 10 transmits a request packet requesting a response, to other home networks through the power line 13. At this time, the adaptor 11-0 adds the home code of itself to the request packet transmitted by the network managing unit 10. In case the adaptor 11-0 is the wireless modem, the request packet is transmitted to other home networks by wireless.

Additionally, responses of other home adaptors or appliances to the request packet are waited for a predetermined time, that is, for three seconds. If there are not the responses of other network adaptors or appliances, the network managing unit 10 retransmits the request packet to the power line 13 three times more. This is an initial installation procedure in a state where the home code is not set to the adaptors 11-1 to 11-n and the appliances 12-1 to 12-n of a user's home. Therefore, the adaptors 11-1 to 11-n and the appliances 12-1 to 12-n cannot respond to the request packet.

If there is no response after three times transmission of the request packet, it is determined that a currently created home code of the adaptor 11-0 is not used in other home networks. After the network managing unit 10 confirms that there is no response from other home adaptors or appliances, it transmits a “home code setting command” packet to the adaptor 11-0 (S26). The adaptor 11-0 receiving the home code setting command sets the created home code as the home code of itself, and annexes the home code of the adaptor 11-0 itself to a head of the home code setting command. Additionally, in order to set the home code to the adaptors 11-1 to 11-n, the home code setting command including the home code is transmitted to the adaptors 11-1 to 11-n (S27). Next, the adaptors 11-1 to 11-n set the home code existing at the head of the home code setting command, as the home code of itself. Accordingly, the same home code is set to the adaptors 11-0 to 11-n.

If there are responses of other home adaptors or appliances through the power line 13 or by wireless in the step S25, the network managing unit 10 determines that the home code of the adaptor 11-0 is already in use. At this time, the network managing unit 10 transmits a “home code clear command” packet to the adaptor 11-0 so as to delete the home code of the adaptor 11-0 (S28). After that, the home code creating step is resumed therefrom (S23) If it is determined that the new appliance is additionally installed in the step S22, the network managing unit 10 transmits the “home code setting command” packet to the adaptor 11-0 (S26). Additionally, the adaptor 11-0 receiving the home code setting command transmits the home code setting command including the home code of the adaptor 11-0 to the new adaptor so as to set the home code to the new adaptor connected to the new appliance (S27). Accordingly, the home code being the same as that of the adaptors 11-0 to 11-n is set to the new adaptor.

If the home code is once set through the above-described procedure, the home code is limited in change and read. This is because in case the home code can be changed, the third party can use an application program to cause a home code change such that the third party can detect it.

However, since there is also the case where the home code change is required, for example, only a development department or a service center for the home network system is limitedly allowed to change and read the home code. Limitedly, the change and read of the home code is briefly described in the following.

The home code of the adaptor 11-0 connected to the network managing unit 10 can be changed by the home code clear command (S28), but since the command is not transmitted through the power line 13, the home code of the adaptors 11-1 to 11-n connected to the appliances 12-1 to 12-n cannot be changed.

In case the adaptors 11-1 to 11-n are embedded into the appliances 12-1 to 12-n, the home code setting can be achieved using the home code change command so as to reset the home code when the appliance is moved between the networks. For this, only the adaptor 11-0 connected to the network managing unit 10 can transmit the home code change command through the power line 13.

Next, the home code can be read only through the above-described adaptor 11-0 only for service. That is, when data is transmitted to the appliances 12-1 to 12-n, the general adaptors 11-1 to 11-n transmit only data to the appliances 12-1 to 12-n, but the adaptor 11-0 only for service can receive data including the home code from the appliances 12-1 to 12-n.

### INDUSTRIAL APPLICABILITY

As described above, in the home code setting method of the home network system according to the present invention, a complicated procedure for setting the home code is not required, and the home code can be automatically created and set at the adaptor itself only with user's simple command input. Further, there is an effect that the security is perfectly guaranteed since information on the home code cannot be accessed from an external as well as information on the created home code is not leaked to the external.

While the present invention has been described and illustrated herein with reference to the preferred embodiments thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalents.

1. A method for setting a home code of a home network system having a first adaptor connected with a network managing unit, and second adaptors connected to the first adaptor through a power line or by wireless and respectively connected with appliances, the method comprising the steps of:
creating the home code of the first adaptor;
determining whether or not the home code is duplicated; and
if the home code is not duplicated, setting the home code of the first adaptor to the second adaptors.

2. The method of claim 1, wherein the home code of the first adaptor is created by combining a timing count value and an initial code value of the first adaptor.

3. The method of claim 1, wherein the home code of the first adaptor is randomly created using a random number generator.

4. The method of claim 1, wherein the determining step comprises the steps of:
transmitting a request packet from the network managing unit to the first adaptor;
adding the home code of the first adaptor to the request packet;
transmitting the request packet having the home code to other networks by wireless or through the power line; and
determining that the home code is not duplicated in case there is no response signal to the request packet, and determining that the home code is duplicated in case there is the response signal to the request packet.

5. The method of claim 1, wherein if the home code is duplicated, the home code of the first adaptor is deleted.

6. A method for setting a home code of a home network system having a first adaptor connected with a network managing unit, and second adaptors connected to the first adaptor through a power line or by wireless and connected with each of appliances, the method comprising the steps of:
transmitting a home code create command to the first adaptor from the network managing unit according to a user's command;
creating a home code according to the home code create command at the first adaptor;
determining whether or not the home code is duplicated by the first adaptor;
if the home code is not duplicated, transmitting a home code setting command from the network managing unit to the first adaptor; and
setting the home code of the second adaptors according to the home code setting command at the first adaptor.

7. The method of claim 6, further comprising the step of determining whether the appliance is initially installed or additionally installed, before the home code create command transmitting step.

8. The method of claim 6, wherein the home code of the first adaptor is created by combining a timing count value and an initial code value of the first adaptor.

9. The method of claim 6, wherein the home code of the first adaptor is randomly created using a random number generator.

10. The method of claim 6, wherein the determining step comprises the steps of:
transmitting a request packet from the network managing unit to the first adaptor;
adding the home code of the first adaptor to the request packet;
transmitting the request packet having the home code to other networks by wireless or through the power line; and
determining that the home code is not duplicated in case there is no response signal to the request packet, and determining that the home code is duplicated in case there is the response signal to the request packet.

11. The method of claim 6, wherein the home code setting step comprises the steps of:
annexing the home code of the first adaptor to a head of the home code setting command;
transmitting the home code setting command having the home code to the second adaptors; and
setting the home code annexed to the head of the home code setting command to the home code of the second adaptors.

12. The method of claim 6, wherein if the home code is duplicated, the home code of the first adaptor is deleted.
